(19) United States
(12) Patent Application Publication
(10) Pub. No.: US 2005/0261951 A1
(43) Pub. Date: Nov. 24, 2005

(54) Method and apparatus for processing marketing information

(76) Inventor: Christopher Patrick Tighe, Arlington, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/363,735

(22) PCT Filed: Sep. 10, 2001
(86) PCT No.: PCT/US01/28218

§ 371 Date: Mar. 7, 2003

Related U.S. Application Data
(60) Provisional application No. 60/231,294, filed on Sep. 8, 2000.

(51) Int. Cl. G06F 17/60

(52) U.S. Cl. 705/10

(57) ABSTRACT

A system and method (FIG. 2) for processing marketing information obtained through various sources. Marketing information, for example, a sales lead can be stored in a database (50), allowing access and manipulation of the sales leads and its associated data by multiple users (20). Further, the system and method facilitates communication between the database and other users in order to obtain information on the processing and status of each sales lead entered into the system.

### RELATED APPLICATION

The present application is related to and claims the priority of U.S. Provisional Application No. 60/231,294 filed Sep. 8, 2000, in the name of Christopher Patrick TIGHE, and titled LEAD TRACK SYSTEM, the entire contents of which are fully incorporated herein by reference.

### FIELD OF THE INVENTION

The present invention relates generally to the storage and processing marketing information, databases, and more particularly to a method and system for storing and tracking sales leads obtained through various sources.

### BACKGROUND OF THE INVENTION

In business today, members of a sales department collect many sales leads from different sources, including customer relations, trade shows, staff referrals, sponsorships, advertising, and promotions. In addition, to effectively make use of the collected sales leads, different organizations may have internal procedures, such as designations of accounts, in order to process each collected sales lead.

It is known to use a spreadsheet/database system and method to handle sales leads, allowing a user to enter and store leads into a spreadsheet/database model designed to manage the sales leads. This system may become unwieldy after a heavy volume of sales leads accumulates within the system. As more sales leads are acquired, known systems and methods may be inadequate to handle the volume of leads and information capable of being stored in the database.

It is therefore desirable to provide methods and apparatuses to allow access and management of a larger amount of leads known spreadsheet/database systems and methods and to facilitate the exchange of information between users regarding sales leads.

### SUMMARY OF THE INVENTION

There is provided a method for processing a sales lead which includes entering the sales lead into a processor system; analyzing the associated information in accordance with pre-existing criteria; automatically sending a first notification including the sales lead to a first person in accordance with the analysis for determination of the manner in which to process the sales lead; and automatically sending a second notification to the first person upon failure to receive a response to the first notification within a predetermined time.

Additional features and advantages will be set forth in part in the description which follows, and in part will be obvious from the description, or may be learned by practice of the claims. The features and advantages will be realized and attained by means of the elements and combinations particularly pointed out in the appended claims.

It is to be understood that both the foregoing general description and the following detailed description are exemplary and explanatory only and not restrictive of the appended claims.

### BRIEF DESCRIPTION OF THE DRAWINGS

FIG. 1 is a flowchart of a method for processing sales lead information.

FIG. 2 is a diagram of a system for processing sales lead information.

FIG. 3 is a computer screen shot showing information associated with processing and tracking a sales lead.

FIG. 4 is a block diagram of a method for processing and tracking a sales lead.

FIG. 5 is a flowchart of a process for tracking sales leads.

### DETAILED DESCRIPTION

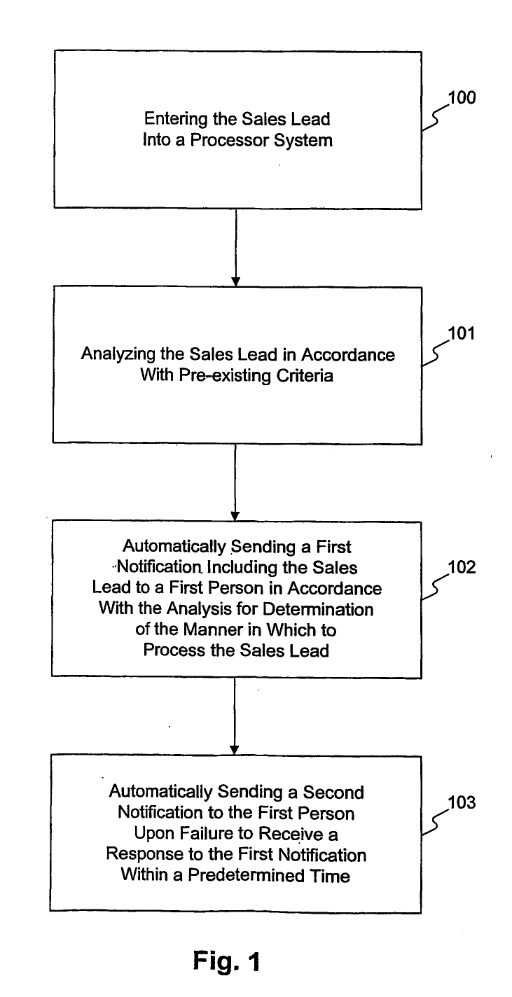

Referring now to the drawings, in which the same reference numbers will be used throughout the drawings to refer to the same or like parts, FIG. 1 is a flowchart of a method for processing sales lead information to be sent, for example, by personnel of a centralized marketing department. A method for automatically processing a sales lead having contact information and associated information, begins at Stage 100, where a user enters a sales lead into a processor system. Once the sales lead is entered, the sales lead is analyzed in accordance with pre-existing criteria (Stage 101). Next at Stage 102, a first notification is automatically sent, including the sales lead, to a first person in accordance with the analysis for determination of the manner in which to process the sales lead. Finally, at Stage 103, a second notification is automatically sent to the first person upon failure to receive a response to the first notification within a predetermined time.

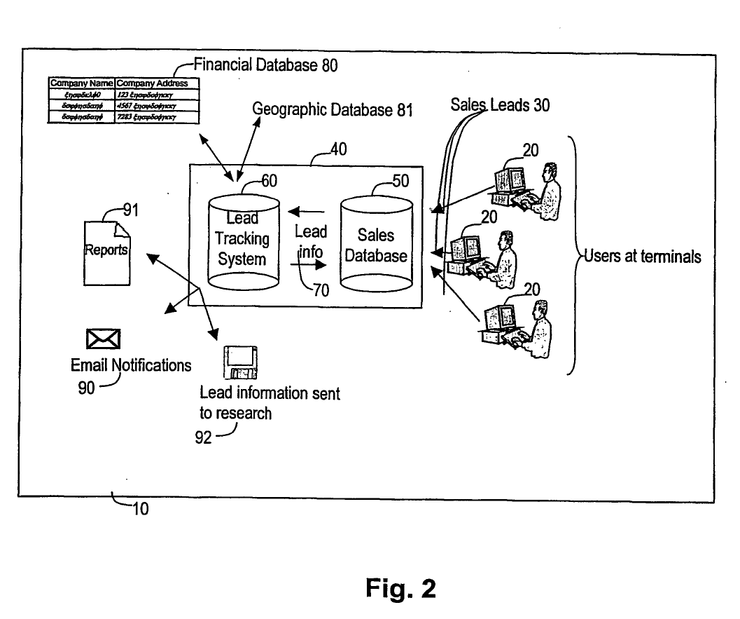

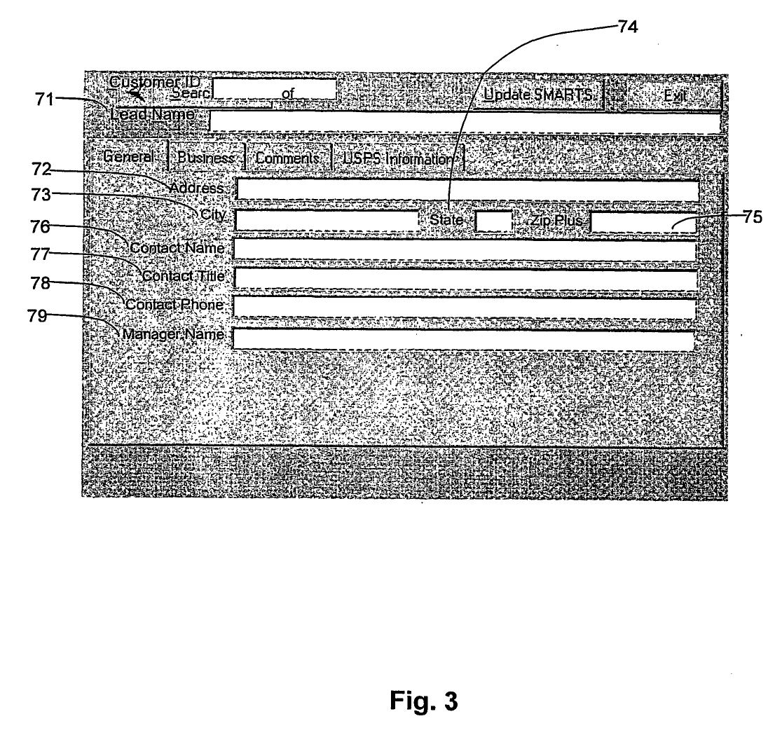

FIG. 2 is a diagram of a system 10 for processing sales lead information, using, for example, the method outlined in FIG. 1. Users at terminals 20 enter sales leads 30 into a processor system 40, which includes a sales database 50 and a lead tracking system 60. Sales lead 30 includes lead information 70 comprising contact information and associated information such as, for example, Lead name 71 (e.g., name of the company which presents a sales opportunity), Address 72, City 73, State 74, ZIP Plus 75, Contact Name 76, Contact Title 77, Contact Phone 78, and Manager Name 79 as shown in FIG. 3.

Sales leads 30 are entered into sales database 50, lead information 70 may be compared against a financial database 80, to determine, for example, whether the lead is associated with an existing account and the amount of revenue involved with the account. Comparison of lead information 70 with financial database 80 permits a determination of the management level to which the individual sales lead 30 should be directed. If sales lead 30 is not associated with an existing account, a determination to assign sales lead 30 is made based on a comparison of lead information 70 with financial database 80, as well as comparison with a geographic database 81.

Lead information 70 may be compared with geographic database 81 which uses, for example, the national ZIP code contained in lead information 70 of sales lead 30 to determine the location of the account and the particular person responsible, using financial information as well as geographic location of sales lead 30. Specifically, by using the financial information obtained from financial database 80, the management level can be determined, and in addition, using the geographic information obtained from geographic database 81, the sales lead can be assigned to a particular person based on the location and management level.

Next, lead tracking system 60 automatically sends a notification 90 by, for example, email on behalf of the central marketing department to the assigned persons as determined from financial and geographic data as explained above, and a response is requested. If no response is received from the assigned person within a predetermined time, a second notification is sent. Lead tracking system 60 may generate reports 91 for the centralized marketing department, and lead information 70 may also be sent elsewhere, for example, to research and development 92, so that the system may be updated and analysis can be performed on existing leads within system 10.

FIG. 3 is a computer screen shot showing solicitation of lead information 70 associated with processing and tracking a sales lead. Lead information 70 may include the following: Lead name 71 (e.g., name of the company which presents a sales opportunity), Address 72, City 73, State 74, ZIP Plus 75, Contact Name 76, Contact Title 77, Contact Phone 78, and Manager Name 79. This is Lead information 70, associated with sales lead 30, provided by users at terminals 20, as shown in FIG. 2.

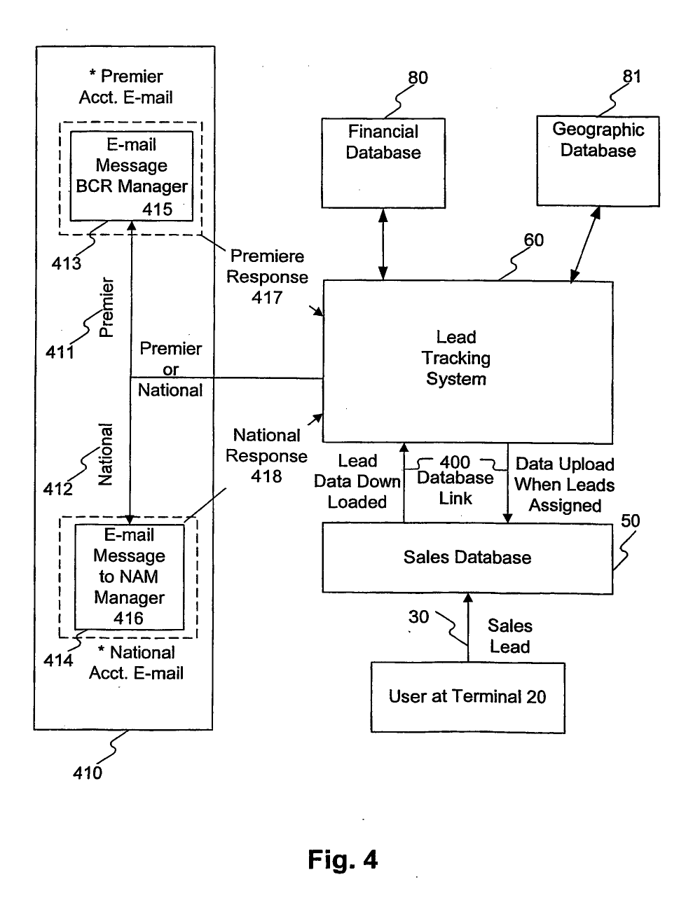

FIG. 4 shows system 10 in greater detail. In FIG. 4, lead tracking system 60 is connected via a database link 400 to sales database 50 and to an e-mail system 410. A user submits sales lead 30 via terminal 20 into sales database 50. Lead tracking system 60 downloads lead information 70 of sales lead 30 via database link 400. As described earlier, lead tracking system 60 may compare sales lead 30 to a financial database 80 and geographic database 81 to determine the correct individual or team to decide the manner in which to pursue sales lead 30. For example, sales leads may be associated with two types of accounts: premier and national. Accounts with revenue potential of, for example, $250,000 or more may be designated as “premier account.” Accounts with revenue potential of, for example, $10 million or more may be designated as “national account.”

If sales lead 30 is associated with a premier account, an e-mail message 413 is sent to the Business Customer Relations (BCR) Manager 415. If sales lead 30 is associated with a national account, an e-mail message 414 is sent to a second level of management, for example, a National Account Manager (NAM) 416.

E-mail messages 413 and 414 may ask permission for the central marketing department to pursue a premier account and national account respectively. E-mail messages 413 and 414 identify sales lead 30 as a premier account or a national account and then asks a series of questions regarding sales lead 30. Either BCR Manager 415 or National Account Manager 416 replies to E-mail message 413 or E-mail message 414 and checks a box, for example, indicating one of three possible responses (proceed without my involvement, partner with me and proceed, or do not approach this opportunity at all). Lead tracking system 60 reads premier response 417 or national response 418 and updates sales database 50 via database link 400 accordingly.

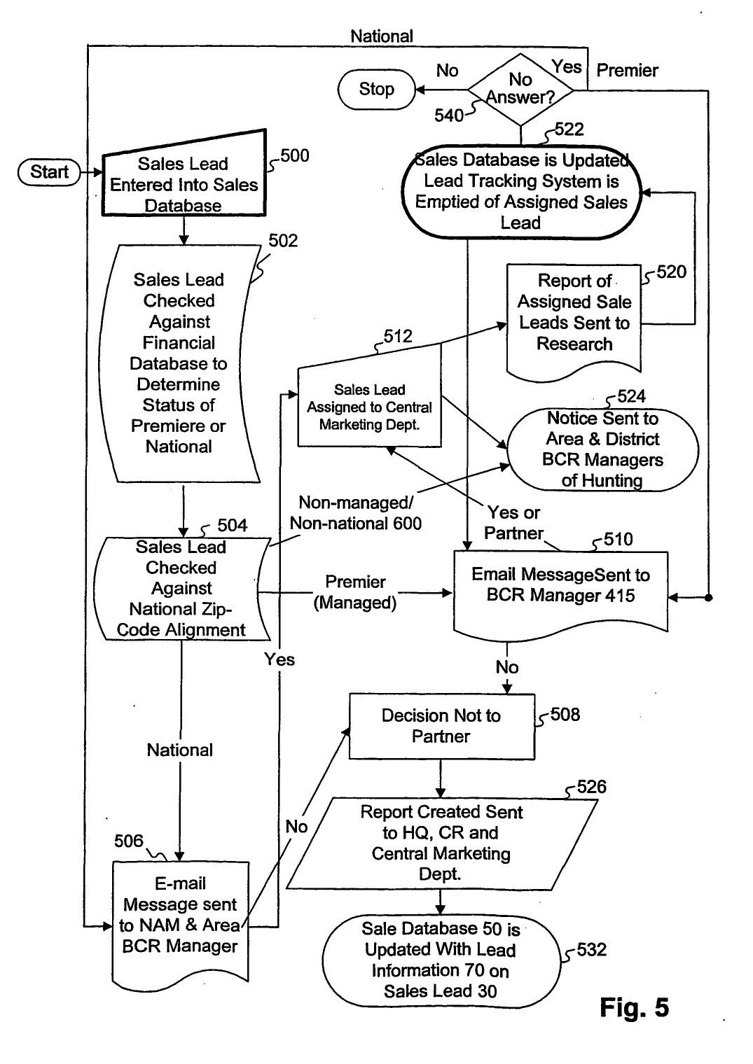

FIG. 5 is a flow chart showing the method of in FIG. 1 in greater detail. At the start of the process, a sales lead is entered into a sales database as shown in Stage 500. Proceeding to Stage 502, the sales lead is compared against a financial database to determine whether the sales lead is associated with a premier account or national account. Next, the sales lead is compared against a geographic database, such as national ZIP Code alignment database, to determine its geographical location, which may be later used to determine the specific person to which the sales lead will be assigned (Stage 504), for example, a National Account Manager or BCR Manager.

At Stage 504, a determination is made as to whether the lead is associated with a premier account or a national account, or a non-premier/non-national account. If the sales lead is identified as a non-premier/non-national account then the sales lead is assigned to personnel at the central marketing department (Stage 512) and a notice is sent to the Area and District BCR Managers (Stage 524), indicating that the sales lead has been assigned to the central marketing department.

If the sales lead is identified as a premier account, the method proceeds to Stage 510, where an e-mail message is sent to the BCR Manager (Stage 510) requesting instructions on how to further process the sales lead.

If the sales lead is identified as a national account, the method proceeds to Stage 506, where an e-mail message is sent to the National Account Manager and Area BCR Manager, requesting instructions on how to further process the sales lead. In each premier account, Business Customer Relations (BCR) managers report to Area BCR Managers. Area BCR Managers are responsible for overseeing customers as well as National Account Managers within an assigned geographical area.

One of the possible outcomes of Stage 506 is a decision by the National Account Manager and the Area BCR Manager to “partner.” Another outcome is “do not proceed to partner.” The final outcome from Stage 506 could be “proceed on own.” If the decision is to “proceed on own” or “partner”, then the method proceeds to Stage 512, where a decision is made by the central marketing department to assign the sales lead to personnel in the central marketing department. If the decision is “not to partner,” the method proceeds to Stage 508, in which the sales lead is archived in the sales database.

A user may then generate a report at Stage 526 which may be sent to the organization's headquarters (HQ) and customer relations department (CR), and then returned to central marketing department. At Stage 526, where sales database is updated with lead information from the sales lead.

If the sales lead is assigned to personnel in a central marketing department and the sales lead is associated with a premier account or national account then an e-mail is sent to BCR Manager or the National Account Manager saying that the central marketing department is pursuing (“hunting”) the sales lead in that particular area (Stage 524). Once responsive e-mails (e.g., premier response 417 and national response 418 of FIG. 4) are sent back to lead tracking system, it reads the response and updates the sales database. The lead tracking system then assigns the sales lead to personnel in a central marketing department.

From Stage 510, a decision is made to partner with Area BCR Manager, to proceed on own, or not to partner. A decision not to partner leads to Stage 508 as described above. A partnering or proceed on own decision leads to Stage 512, where, as described above, the sales lead is assigned to personnel in the central marketing department. Once all assignments are made, a report of assigned sales leads is generated (Stage 520).

After the report of assigned sales lead is generated at Stage 522, the database checks all remaining unassigned opportunities. Once the sales lead is assigned to personnel in central marketing department at Stage 512, the system updates the sales database and the lead tracking system is emptied (Stage 522). In Stage 540, lead tracking system checks which e-mail messages regarding assignment of sales leads have not been answered. If, within, for example, ten calendar days there has not been a response, the system goes to either Stage 506 (Permission Request Sent to National Account Manager and National Account Manager's Area BCR for Empty Opportunities of National Account), or to Stage 510 (Permission Request Sent to Area BCR and Designate as Requested).

To illustrate the above process flow, if a sales lead identified as a national account was submitted, the sales lead would go to the National Account Manager and the Area BCR Manager with a message reading, for example, “We have identified this lead as a national account and w are asking for your permission to proceed. Would you like us to (1) proceed without your permission?; (2) partner with you and proceed? (National Account Manager or Area BCR Manager would include name and phone number of person to partner with); or (3) do not approach this opportunity at all? National Account Manager or Area BCR Manager could respond by checking one of the three boxes. The lead tracking system or personnel operating it would read read the response and update the sales database accordingly. If the message requesting instruction is not answered within, for example, ten calendar days, or any predetermined time period, the lead tracking system automatically sends a message reading, for example, “We have not heard from you. We would like your response.” The message and time period are programmable to suit the users needs.

To further illustrate, suppose fifty sales leads 30 have come in to the lead tracking system 60. Further suppose, ten sales leads are identified as premier or national accounts, and ten e-mail messages have been sent out requesting permission to pursue. Also, five sales leads have been responded to, leaving five sales leads outstanding. The lead tracking system now has 45 sales leads awaiting assignment, assuming that the other 40 sales leads were not identified as premier or national accounts. The lead tracking system would then assign those 45 sales leads to personnel in central marketing department. Once that is done, the lead information is uploaded into the sales database. Assigned sales leads are recorded in a report providing a record of every transaction that has taken place and where that transaction occurred. Once the sales leads are updated into the sales database, those sales leads (in the instant example, those 45 assigned sales leads 30) are erased within the lead tracking system, which enables the system to be more efficient. This overcomes the problem of having an extremely unwieldy large database and spreadsheet once many leads are accumulated.

Other embodiments of the invention will be apparent to those skilled in the art from consideration of the specification and practice of the appended claims disclosed herein. It is intended that the specification and examples be considered as exemplary only, with a true scope and spirit being indicated by the following claims.

1. A method for automatically processing a sales lead having contact information and associated information, comprising:
entering the sales lead into a processor system;
analyzing the sales lead in accordance with pre-existing criteria;
automatically sending a first notification including the sales lead to a first person in accordance with the analysis for determination of the manner in which to process the sales lead; and
automatically sending a second notification to the first person upon failure to receive a response to the first notification within a predetermined time.

2. The method of claim 1, wherein analyzing comprises comparing the associated information to a financial database and wherein sending comprises sending to a person associated with a location and having a management level related in accordance with the financial database comparison.

3. The method of claim 2, wherein analyzing further comprises comparing the contact information with a geographical database, and wherein sending comprises sending to a person associated with a location determined by the geographic database comparison and in accordance with the management level determined with the financial database comparison.

4. The method of claim 3, wherein the geographical database contains information including the National ZIP Code alignment.

5. The method of claim 1, further comprising receiving a response to the first notification which indicates the disposition of the sales lead.

6. The method of claim 5, further comprising updating the processor system in accordance with the response to the first notification.

7. The method of claim 5, further comprising pursuing the sales lead in accordance with the response.

8. The method of claim 7, further comprising removal of sales lead from the processor system after disposition of the sales lead.
